(19) United States
(12) Patent Application Publication
(10) Pub. No.: US 2016/0174744 A1
(43) Pub. Date: Jun. 23, 2016

(54) Child Place Mat with Voice Recording

(71) Applicant: Rebekah Bawden, North Salt Lake, UT (US)

(72) Inventor: Rebekah Bawden, North Salt Lake, UT (US)

(21) Appl. No.: 14/981,770

(22) Filed: Dec. 28, 2015

Related U.S. Application Data
(60) Provisional application No. 62/095,777, filed on Dec. 23, 2014.

(51) Int. Cl. A47G 23/03; H04R 1/02; G09B 5/04

(52) U.S. Cl. CPC A47G 23/0306; G09B 5/04; A47G 23/0303; H04R 1/028

(57) ABSTRACT

A child's place mat with a voice recording feature prevents spills. The place mat is waterproof, dishwasher safe, and semi-rigid such that it may be used as a serving tray in some situations. The edge of the place mat is raised to contain spills. Within the place mat, a battery-powered memory device, a microphone, and a speaker are provided in a removable insert, enabling the adult user to record and play brief messages, such as commands or words of encouragement, for the child. The insert also provides a tilt sensor, such that when the place mat is tilted to the extent that there is risk of a spill, an audible alert is provided by the speaker. The top surface of the place mat may provide dividers similar to a cafeteria tray, and a circular ridge to secure a cup or bowl.

### CROSS-REFERENCE TO RELATED APPLICATIONS

This Application claims the benefit of U.S. Provisional Application No. 62/095,777, filed Dec. 23, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to child care accessories and in particular to a child's place mat with a voice recording feature. For toddlers, the transition from dining in a high chair to a place at the table with the adults is difficult and messy. Any accessory which will ease this transition and help contain the mess would be well received.

A search of the prior art reveals various mats which have been developed to secure bowls, plates, drinking vessels, and utensils, and keep a young child entertained. None are closely related to the present invention, but several include features which resemble those of the present invention. Each has proven to be less than satisfactory in its own way. The present invention has been developed for the purpose of addressing and resolving these disadvantages.

Child's serving mat, U.S. Pat. No. 5,053,262 (priority Jul. 16, 1990), provides a mat construction defined by a flexible central web to define a sanitary top surface, wherein a matrix of suction cups are mounted to an associated bottom surface to permit the mat structure to be rolled up prior to and subsequent to use. Modifications of the invention include a flexible wall integrally mounted to the central web wherein the central web is formed with a concave surface to accommodate fluid medially of the central web and wherein suction cups are arranged adjacent opposed side edges of the central web to effect the concave configuration of the mat structure.

Child's multipurpose, multisectional mat with carrying handles, U.S. Pat. No. 5,491,851 (priority Feb. 1, 1994), provides a multipurpose, multisectional mat for a child's use in resting, sitting, lying, reading and like activities. The mat is comprised of multiple articulated sections interconnected to form a mat which, when flat, provides a continuous resting surface formed by edge-to-edge abutting sections to accommodate a recumbent child and which, when folded with the sections abutted face-to-face, will provide a child's seat or table. Each section comprises a generally rectangular soft cushion pad of substantial thickness and resilience and a fabric cover covering the pad, the fabric being locally continued beyond the pads alternately high and low, and joined there as a hinge between adjacent pads for edge-to-edge or face-to-face orientation.

Child's travel mat, U.S. Patent App. Pub. No. US2012/0020586 (priority Jul. 16, 2009), provides a travel mat having a plurality of activities for young children attached to and distributed thereon. The travel mat comprises a fabric panel of an appropriate size to be received on an airplane tray table or on a travel tray intended for use in an automobile. Toys and activities are provided on both the front and back side of the tray wherein the tray can be flipped as desired to change the set of toys with which the child is playing. At least one pair of straps is provided to secure the mat to a desired tray. Because of the flexible nature of the mat, it can be easily folded and stowed for transport such as in a diaper bag or a purse.

Placemat member, U.S. Pat. No. 6,746,735 (priority Aug. 28, 2002), provides a placemat device, which is intended for use by children, whereby the placemat device has a sheet member and a scoop, with the scoop designed to receive and hold the sheet member when put in a storage position. Additionally, the placemat can include indicia, which are intended for children. A plurality of suction cups are optionally attached to the sheet member. An alternative to the suction cups would be any member or construction that allows the placemat to be removably affixed to a surface. For example, an adhesive strip could be used. Also, a material that is slip resistant and tacky could be used to form the sheet member.

Reusable placemat, U.S. Patent App. Pub. No. US2007/0051864 (priority Sep. 7, 2005), provides a cost effective, durable, safe, and washable placemat which has a substantially planar eating surface that is encircled by a spill retention rim, with a food retention gutter detachably secured thereto. A resilient strip of material preferably encircles the lower side of the placemat, thereby defining a non-slip foot. The planar eating surface may be substantially transparent, thereby allowing one or more activity cards to be displayed therethrough.

Table mat for child, Chinese Patent No. CN203873472 (priority Apr. 2, 2013), provides a table mat for a child. The table mat comprises a mat body and a bearing disk, wherein the mat body is provided with an upper surface and a protruding edge arranged along the edge of the mat body, the protruding edge protrudes out of the upper surface, the bearing disk comprises a back plate and a bearing carrier plate, the back plate and the front end edge of the mat body are integrally connected and extend downwards, the bearing carrier plate extends forwards from the lower end edge of the back plate, a containing space is formed by the bearing carrier plate and the back plate, an arc concave end edge is arranged at the front end of the bearing carrier plate, the bearing disk is provided with two side plates, the containing space is formed between the two side plates, and the two ends of the protruding edge are integrally connected with the upper end edges of the side plates respectively. Therefore, the effect of bearing food which falls and food residues which fall off when a young child eats is improved.

Most of these inventions mat to the table or other flat serving surface with suction cups, straps, adhesive strips, or similar devices to prevent catastrophic spills. This creates a disadvantage by making the mat difficult to remove, pick up, and handle after the meal for cleaning purposes. The proliferation of small, high-powered, but inexpensive electronic components in a broad array of consumer products which were originally entirely mechanical in nature has pointed the way to a solution. The present invention, which provides an electronic component to detect a spill risk and sound an alarm, resolves the disadvantages of the prior art and is not anticipated by the prior art.

A child's place mat with a voice recording feature, providing a raised edge to contain spills and the ability to record and play a parent's voice messages, as well as detecting a spill risk and sounding an alarm, would resolve this problem.

### SUMMARY OF THE INVENTION

Accordingly, the invention is directed to a child's place mat with a voice recording feature. The place mat is waterproof, dishwasher safe, and semi-rigid such that it may be used as a serving tray in some situations. The edge of the place mat is raised to contain spills. Within the place mat, a battery-powered memory device, a microphone, and a speaker are provided in a removable insert, enabling the adult user to record and play brief messages, such as commands or words of encouragement, for the child. The insert also provides a tilt sensor, such that when the place mat is tilted to the extent that there is risk of a spill, an audible alert is provided by the speaker. The top surface of the place mat may provide dividers similar to a cafeteria tray, and a circular ridge to secure a cup or bowl.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

FIG. 1 shows a top perspective view of the first exemplary embodiment, displaying the place mat 10, the top surface 10A, the edge 11, the side surface 12, the insert 13, and the power switch 14.

FIG. 2 shows a bottom view of the first exemplary embodiment, displaying the bottom surface 10B, the insert 13, the speaker 15, the microphone 16, the grip pads 18.

FIG. 3 shows a system diagram of the first exemplary embodiment showing the recording and playback process and the tilt monitor process.

FIG. 4 shows a top view of a second exemplary embodiment showing the place mat 10 dividers 21 and circular ridge 20.

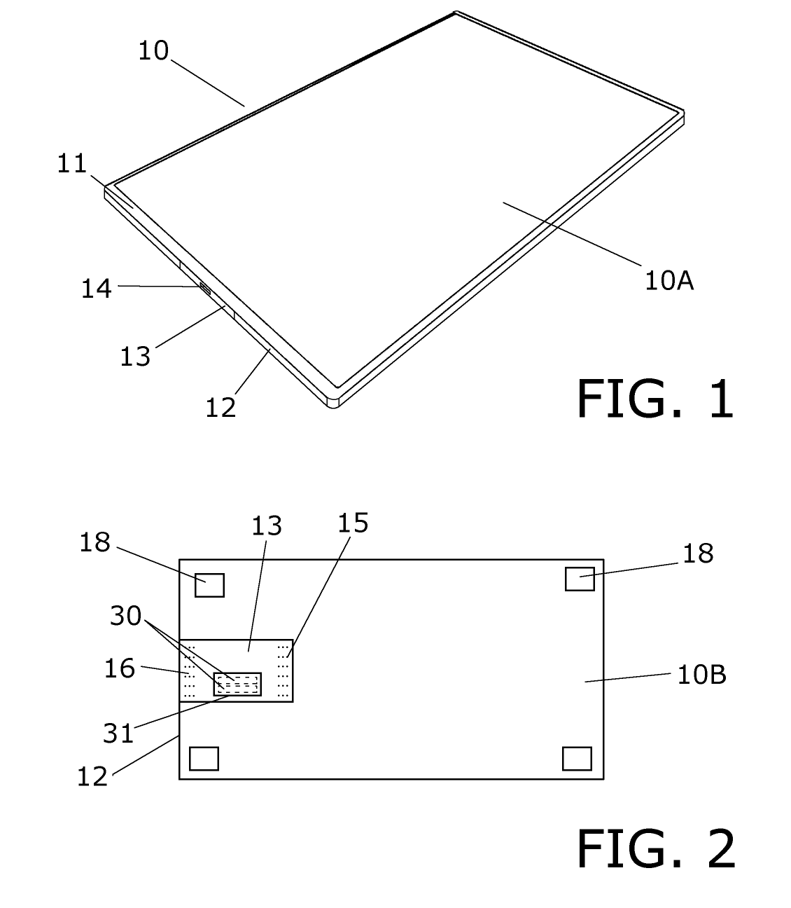

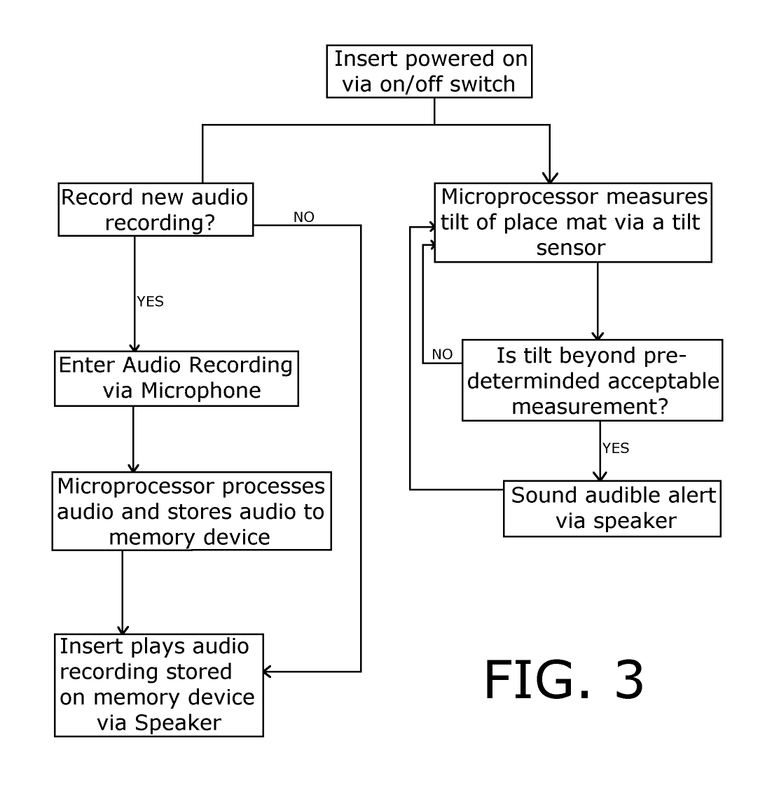

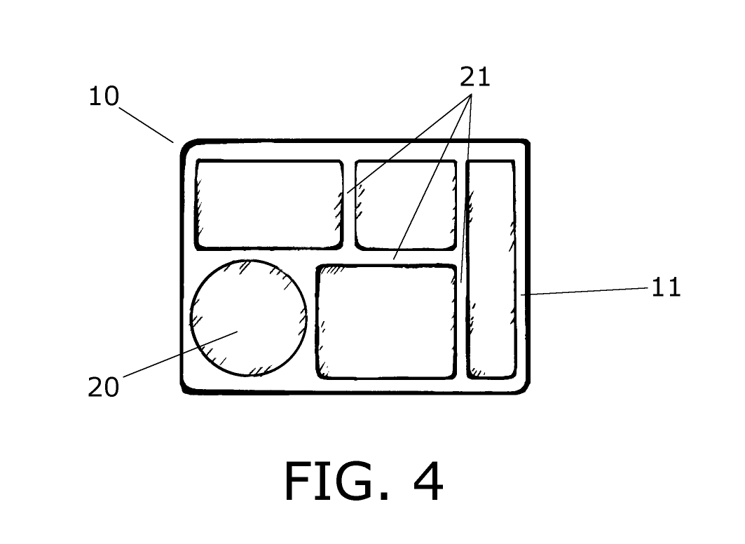

### DETAILED DESCRIPTION OF THE INVENTION

Referring now to the invention in more detail, the invention is directed to a child's place mat 10 with a voice recording feature.

The first exemplary embodiment is comprised of a place mat 10 which is waterproof, dishwasher safe, and semi-rigid such that it may be used as a serving tray in some situations. The place mat 10 is preferably rectangular, eighteen inches in length, and thirteen inches in width. The edge 11 of the place mat 10 is raised half an inch to contain spills on the top surface 10A of the place mat 10.

Within the place mat 10, a battery-powered memory device, a microphone 15, and a speaker 16 are provided in a removable insert 13, enabling the adult user to record and play brief messages, such as commands or words of encouragement, for the child. The batteries 30 being located within a battery compartment 31. The insert 13 also provides a tilt sensor, such that when the place mat 10 is tilted to a predetermined angle such that there is risk of a spill, an audible alert is provided by the speaker 16. The bottom surface 10B of the place mat 10 provides a recess for the insert, and a non-slip texture such that the place mat 10 will not slide across the table surface. The non-slip texture may be provided in grip pads 18, or cover the entire bottom surface 10B of the place mat 10. The position of the insert 13 is preferably adjacent to one side 12 of the place mat 10, such that an power switch 14 for the insert 13 is easily accessible from the side without lifting the place mat 10 or disturbing its contents.

The place mat 10 is preferably provided in a broad range of bright colors and patterns, and may provide illustrations such as licensed or public domain cartoon characters, sports team logos, jungle animals, flowers, marine life, or dinosaurs. Alternate embodiments, wherein the top surface 10A of the place mat 10 may provide dividers 21 similar to a cafeteria tray, or a circular ridge 20 to secure a cup or bowl, are contemplated.

To use the first exemplary embodiment, the user places the insert in the place mat 10, lays the place mat 10 on the table in the desired position, places food and beverage items on the top surface of the place mat 10, and activates the on/off switch on the side surface. When the meal is finished, the adult user deactivates the on/off switch, removes the insert, and may clean the place mat 10 by hand or with a dishwasher.

Electronic components of the insert preferably include a microprocessor, a memory device, a microphone, a speaker, an on/off switch, and one or more replaceable batteries.

The place mat 10 is preferably manufactured from a semi-rigid, durable material which is waterproof and dishwasher safe, such as silicone. The insert is preferably manufactured from rigid, durable materials such as steel, aluminum alloy, plastic, brass, and copper alloy. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A child's place mat comprising:
a. a place mat having a top surface, bottom surface, edge, and at least one side;
b. an insert;
c. said insert comprising a memory device, a speaker, a microphone, a battery compartment, one or more batteries, and a power switch;
d. said memory device, speaker, and said microphone being in electronic communication with a microprocessor; and
e. said insert being configured to record audio via said microphone, store said recorded audio via said memory device, and playback said recorded audio via said speaker.

2. The child's place mat of claim 1, wherein said edge is raised above the top surface.

3. The child's place mat of claim 1, wherein said place mat is rectangular in shape.

4. The child's place mat of claim 1, wherein said insert further provides a tilt sensor;
said tilt sensor being configured to measure a tilt angle of said place mat; and said insert is configured to play an audio alert if said tilt angle reaches a predetermined angle.

5. The child's place mat of claim 1, wherein said bottom surface provides a recess and said insert is placed within said recess.

6. The child's place mat of claim 5, wherein said recess is positioned adjacent to said side such that said power switch is accessible through said side.

7. The child's place mat of claim 6, wherein said insert further provides a tilt sensor;
said tilt sensor being configured to measure the tilt angle of said place mat; and said insert is configured to play an audio alert if said tilt angle reaches a predetermined angle.

8. The child's place mat of claim 1, wherein said insert is positioned adjacent to said side such that said power switch is accessible on said side.

9. The child's place mat of claim 8, wherein said insert further provides a tilt sensor;
said tilt sensor being configured to measure the tilt angle of said place mat; and said insert is configured to play an audio alert if said tilt angle reaches a predetermined angle.

10. The child's place mat of claim 1, further comprising a non-slip texture on said bottom surface.

11. The child's place mat of claim 10, wherein said non-slip texture is a plurality of grip pads located at corners of the place mat.

12. The child's place mat of claim 1, wherein the place mat is provided in a broad range of bright colors and patterns.

13. The child's place mat of claim 1, wherein the place mat provides illustrations such as licensed or public domain cartoon characters, sports team logos, jungle animals, flowers, marine life, or dinosaurs.

14. The child's place mat of claim 1, further providing dividers; said dividers being located on the top surface; said dividers being raised above said top surface; a circular ridge; and said circular ridge being configured to secure a bowl or cup.

15. The child's place mat of claim 2, further providing dividers; said dividers being located on the top surface; said dividers being raised above said top surface; a circular ridge; and said circular ridge being configured to secure a bowl or cup.

16. The child's place mat of claim 4, further providing dividers; said dividers being located on the top surface; said dividers being raised above said top surface; a circular ridge; and said circular ridge being configured to secure a bowl or cup.

17. The child's place mat of claim 6, further providing dividers; said dividers being located on the top surface; said dividers being raised above said top surface; a circular ridge; and said circular ridge being configured to secure a bowl or cup.

18. The child's place mat of claim 7, further providing dividers; said dividers being located on the top surface; said dividers being raised above said top surface; a circular ridge; and said circular ridge being configured to secure a bowl or cup.

19. The child's place mat of claim 9, further providing dividers; said dividers being located on the top surface; said dividers being raised above said top surface; a circular ridge; and said circular ridge being configured to secure a bowl or cup.

20. The child's place mat of claim 10, further providing dividers; said dividers being located on the top surface; said dividers being raised above said top surface; a circular ridge; and said circular ridge being configured to secure a bowl or cup.
